(19) United States
(12) Patent Application Publication
(10) Pub. No.: US 2026/0105914 A1
(43) Pub. Date: Apr. 16, 2026

(54) PROVIDING CONTEXT-SENSITIVE INTERACTIONS BETWEEN AN AUTONOMOUS VEHICLE AND A PASSENGER

(71) Applicant: International Business Machines Corporation, Armonk, NY (US)

(72) Inventors: Shunguo Yan, Austin, TX (US); Su Liu, Austin, TX (US); Zhennan Wang, Austin, TX (US); Faheem Altaf, Pflugerville, TX (US)

(21) Appl. No.: 18/911,313

(22) Filed: Oct. 10, 2024

(51) Int. Cl. G10L 15/183; G01C 21/36; G09B 21/00; G10L 13/033; G10L 15/22; G10L 15/30

(52) U.S. Cl. CPC G10L 15/183; G01C 21/3679; G01C 21/3691; G01C 21/3697; G09B 21/006; G10L 13/033; G10L 15/22; G10L 15/30; G10L 2015/228

(57) ABSTRACT

Examples described herein provide systems and methods for enhancing user interactions with an autonomous vehicle through context-sensitive responses. Aspects include receiving a query from a passenger within an autonomous vehicle. obtaining context data from onboard sensors, a high-definition map, and one or more cloud services, and creating a context-enriched prompt based on the query and the obtained context data. Aspects also include transmitting the context-enriched prompt to a generative AI system to generate a response, receiving the response from the generative AI system, converting the response into a spoken response using a speech processing module, and outputting the spoken response to the passenger.

### BACKGROUND

The disclosure generally relates to autonomous vehicle technologies, specifically to enhancing interactions between autonomous vehicles and users through computer-based context-sensitive systems.

Emerging autonomous transportation offers new possibilities for mobility. Experts predict that fully autonomous vehicles will become commercially available on roads by 2030. These vehicles promise to provide physically impaired individuals with a level of freedom and independence. Despite these advancements, current technologies do not fully meet the expectations of physically impaired passengers (e.g., visually impaired passengers). While sighted passengers can enjoy visual experiences during a journey, visually impaired passengers often miss out on these aspects, leading to a less engaging travel experience.

### SUMMARY

According to one aspect of the present invention, a computer-implemented method for enhancing user interactions with an autonomous vehicle through context-sensitive responses is provided. The method comprises receiving a query from a passenger within an autonomous vehicle, obtaining context data from onboard sensors, a high-definition map, and one or more cloud services, and creating a context-enriched prompt based on the query and the obtained context data. The method also comprises transmitting the context-enriched prompt to a generative AI system to generate a response, receiving the response from the generative AI system, converting the response into a spoken response using a speech processing module, and outputting the spoken response to the passenger

The above features and advantages, and other features and advantages, of the disclosure, are readily apparent from the following detailed description when taken in connection with the accompanying drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of one or more embodiments described herein are apparent from the following detailed description taken in conjunction with the accompanying drawings in which:

FIG. 1 illustrates a block diagram of a computing environment, according to one or more embodiments;

FIG. 2 illustrates a block diagram of a system for providing context-sensitive interactions between an autonomous vehicle and a passenger according to one or more embodiments;

FIG. 3 illustrates a flow chart diagram of a method for enhancing user interactions with an autonomous vehicle through context-sensitive responses according to one or more embodiments;

FIG. 4 illustrates a flow chart diagram of a method for enhancing user interactions with an autonomous vehicle through context-sensitive responses according to one or more embodiments; and

FIG. 5 illustrates a flow chart diagram of a method for enhancing user interactions with an autonomous vehicle through context-sensitive responses according to one or more embodiments.

The detailed description explains embodiments of the disclosure, together with advantages and features, by way of example with reference to the drawings.

### DETAILED DESCRIPTION

Visual impairment affects a significant portion of the global population, with approximately 2.2 billion individuals experiencing some form of visual impairment, including 20 million in the United States. This condition poses substantial challenges to independence and mobility, particularly for those aged 65 and older. Individuals with visual impairments face legal and practical obstacles in driving, which limits their autonomy and access to transportation.

Current autonomous vehicle technologies, while promising, do not fully address the needs of visually impaired passengers. Existing solutions often focus on driving assistance or vehicle control adaptations, which may not provide a comprehensive experience for visually impaired passengers. These technologies typically lack the ability to engage visually impaired passengers in meaningful interactions during their journey, resulting in a less engaging travel experience.

Exemplary embodiments comprise a computer-implemented approach to create context-sensitive interactions between visually impaired or blind passengers and self-driving vehicles. This method aims to transform a self-driving journey into an interactive and enjoyable expedition by integrating a dynamic context with High Definition (HD) maps and vehicle onboard sensors. The system enriches passenger queries with current context, utilizing a generative AI model and cloud services to provide answers and initiate conversations based on locations, points of interest, and passenger preferences.

Descriptions of various embodiments of the present disclosure are presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

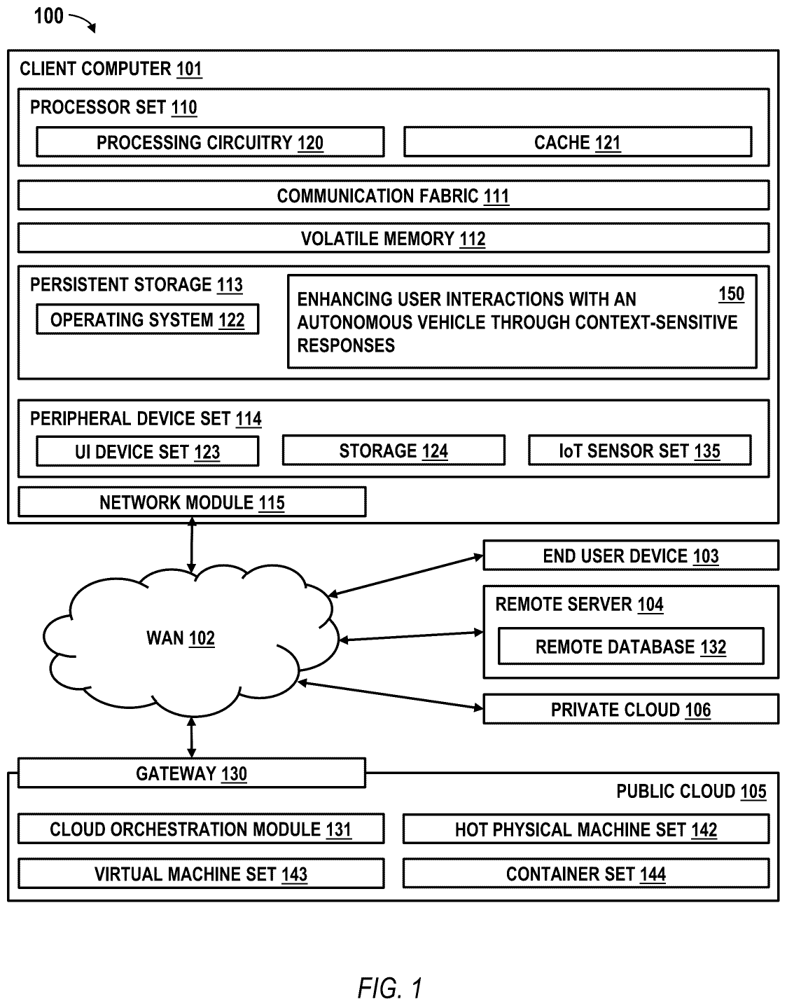

FIG. 1 illustrates a computing environment 100, according to an embodiment. Computing environment 100 contains an example of an environment for the execution of at least some of the computer code includes enhancing user interactions with an autonomous vehicle through context-sensitive responses, as shown at block 150. In addition to a controller for controlling the operations of a metal cutting tool, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122, as identified above), peripheral device set 114 (including user interface (UI) device set 123, storage 124, and Internet of Things (IoT) sensor set 135), and network module 115. Remote server 104 includes remote database 132. Public cloud 105 includes gateway 130, cloud orchestration module 131, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 132. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in persistent storage 113 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 135 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 132 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 131. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 131 manages the transfer and storage of images, deploys new instantiations of VCEs and manages active instantiations of VCE deployments. Gateway 130 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to one or more embodiments, the computing environment 100 can provide remote data storage. For example, the computer 101 can be a cloud storage system or other suitable system for storing data that is accessible to a user remotely, such as by accessing the computer 101 using the end user device 103. That is, a user can send a user operation (also referred to as a “user request”) from the end user device 103 to the computer 101 via the WAN 102. Although the user operation may appear to be simple, such as uploading an object to a cloud storage system, the complications of operating a cloud computing system often have side effects and produce ancillary data, which may be consumed by both the operator of the system (e.g., the computer 101) and by users or other components of the cloud architecture (e.g., the computing environment 100). Ancillary data may be created by user operations that trigger the creation of the ancillary data. Ancillary data may be resource consumption information, notification data, and/or the like, including combinations and/or multiples thereof. Data for an independent event may be inferred from another event (e.g., event to update resource consumption information for an entity in a system also means that the total consumption information for the owner of the entity is also updated).

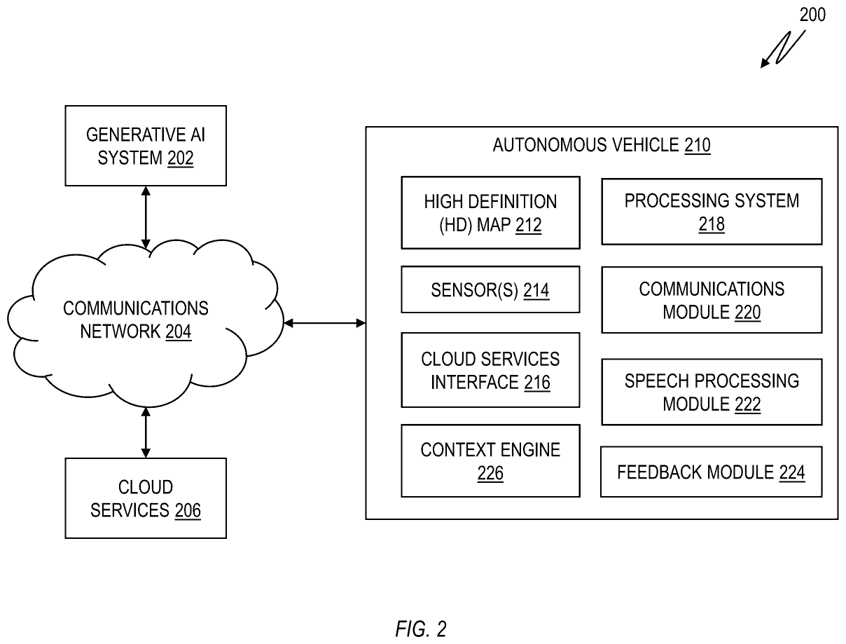

Referring now to FIG. 2, a block diagram of a system 200 for providing context-sensitive interactions between an autonomous vehicle and a passenger is provided. The system 200 includes several components that work together to provide context-sensitive interactions between an autonomous vehicle and a passenger. In exemplary embodiments, the system 200 includes a generative AI system 202, one or more cloud services 206 and an autonomous vehicle 210 that are configured to communicate with one another via a communications network 204. In exemplary embodiments, the communications network 204 may include both private and public networks, such as a cellular communications network and the Internet.

In exemplary embodiments, the generative AI system 202 is a sophisticated component that processes a prompt to generate content. In exemplary embodiments, the generative AI system 202 may be a large language model, such as ChatGPT 4.0 by OpenAI, LLaMA by Meta, BERT by Google, or the like.

In exemplary embodiments, the cloud services 206 are external data sources that provide information, such as real-time information, to the autonomous vehicle 210. For example, autonomous vehicle 210 may retrieves data such as local weather, news, and events from various cloud services 206 through APIs, ensuring that the passenger receives the most current and relevant updates during their journey. This integration of external information enhances the overall experience by seamlessly incorporating it into the vehicle's responses. For instance, weather APIs offer up-to-date forecasts and conditions, allowing the system to inform the passenger about weather changes along their route. News feeds deliver the latest updates, keeping the passenger informed about significant local or global events. Event listings provide information about local happenings, such as concerts or festivals, that might interest the passenger. Additionally, traffic data services offer real-time road conditions and alternative routes, helping the vehicle navigate efficiently and keep the passenger informed.

In exemplary embodiments, the autonomous vehicle 210 includes various subsystems that are configured to operate the autonomous vehicle 210 and to interact with the passenger(s). In one embodiment, the autonomous vehicle 210 includes a high-definition (HD) map 212, one or more sensor(s) 214, a cloud services interface 216, a processing system 218, a communications module 220, a speech processing module 222, a feedback module 224, and context engine 226.

In exemplary embodiments, the high-definition (HD) map 212 is an annotated map that includes detailed location data and points of interest. It uses high-resolution mapping technology to identify an exact location of a vehicle on a roadway and the map is annotated with information regarding the geographic areas. For example, the annotations may include nearby parks or historical sites. In exemplary embodiments, the autonomous vehicle 210 utilizes the HD map 212 to both control the operation of autonomous vehicle 210 and to obtain context data regarding the location of the autonomous vehicle 210.

In exemplary embodiments, the autonomous vehicle 210 is equipped with cameras and other sensors, the sensors 214 that are configured to capture images and detect roadside events, passenger's mood, and interests. These sensors employ image recognition and mood detection algorithms to identify scenic views and notify the passenger accordingly. The sensors 214 in the autonomous vehicle encompass a range of devices that are designed to capture and interpret the environment effectively. These sensors collaborate to detect roadside events, passenger's mood, and interests, thereby enhancing the interaction with the passenger. For instance, Lidar sensors use laser light to measure distances and create detailed 3D maps of the surroundings, aiding in obstacle detection and safe navigation. Radar sensors employ radio waves to determine the speed and distance of objects, providing essential data for collision avoidance and adaptive cruise control. Microphones capture ambient sounds, enabling the system to recognize auditory cues such as sirens or honking, which are vital for situational awareness. Infrared sensors detect heat signatures, useful for identifying living beings or vehicles in low-light conditions. Additionally, ultrasonic sensors, often used for parking assistance, measure the distance to nearby objects using sound waves, ensuring precise maneuvering in tight spaces. In exemplary embodiments, the sensors 214 can also be used to determine more accurate information of the surroundings the passenger is interested in, for example, head facing direction (e.g., left, right, back, front).

In exemplary embodiments, the cloud services interface 216 is configured to connect the autonomous vehicle 210 to cloud services 206 to obtain additional data that is not stored in the HD map 212. In one embodiment, the cloud services interface 216 uses secure connections to access real-time weather forecasts and other pertinent information, enhancing the vehicle's ability to provide comprehensive answers to the passenger's queries.

In exemplary embodiments, the data processing and system operations are managed by a processing system 218. This component integrates sensor data with AI-generated content, using powerful processors to ensure smooth and efficient system performance. Various devices can serve as the processing system 218, each offering unique capabilities. High-performance CPUs, with multiple cores and threads, handle complex computations and multitasking efficiently. GPUs are ideal for parallel processing tasks, such as image recognition and machine learning, providing the necessary computational power for real-time data analysis. FPGAs offer customizable hardware acceleration, allowing for tailored processing capabilities to meet specific system requirements. ASICs, designed for specific tasks, provide optimized performance for particular functions within the vehicle's processing system. For cutting-edge applications, quantum processors can perform complex calculations at unprecedented speeds, potentially enhancing the vehicle's decision-making capabilities.

In exemplary embodiments, the communications module 220 is configured to facilitate communication between the autonomous vehicle 210 and external systems, such as the generative AI system 202 and the cloud services 206. The communications module 220 employs advanced communication protocols to maintain a continuous data flow, ensuring that the passenger receives uninterrupted information. Examples of technologies used in this communications module 220 include cellular networks, which provide wide-area connectivity for real-time data exchange, and Wi-Fi, which offers high-speed local communication. Additionally, Bluetooth technology enables short-range communication with nearby devices, while satellite communication ensures connectivity in remote areas where traditional networks may be unavailable. These technologies work together to support seamless integration with cloud services and other external data sources, enhancing the overall functionality and responsiveness of the vehicle's systems.

In exemplary embodiments, the speech processing module 222 is configured to convert text-based answers into spoken language. The speech processing module 222 uses natural language processing techniques to read out descriptions of nearby landmarks, making the information accessible and engaging for the passenger. In one embodiment, the speech processing module 222 is configured to adjust the tone and pace of speech to match the passenger's preferences, ensuring a personalized and comfortable experience. This module enhances the journey by providing clear and informative audio feedback, allowing the passenger to enjoy a more interactive and enjoyable expedition.

In exemplary embodiments, the feedback module 224 is configured to collect feedback from the passenger to the passenger's interaction with the autonomous vehicle. In exemplary embodiments, the feedback module 224 is designed to collect various types of feedback from the passenger regarding their interaction with the autonomous vehicle. The feedback can include satisfaction ratings, where passengers rate their overall experience, providing insights into how enjoyable and comfortable the journey was. Voice commands feedback allows passengers to comment on the clarity and responsiveness of voice interactions, helping to refine the speech processing module for better communication. Content preferences feedback enables passengers to indicate their preferences for the type of information they wish to receive, such as more detailed descriptions of landmarks or updates on local events. Route feedback involves comments on the chosen route, including suggestions for alternative paths or points of interest they would like to explore. Additionally, passengers can provide feedback on their mood and comfort levels during the journey, allowing the system to adjust interactions accordingly. In exemplary embodiments, the feedback module 224 may be configured to use machine learning algorithms to analyze feedback and adjust the type of information provided based on passenger preferences, ensuring a tailored and satisfying interaction.

In exemplary embodiments, the context engine 226 is configured to determine a dynamic context that is used to enhance a user query. The context engine 226 may obtain context data from the sensor(s) 214, the HD map 212, and from the cloud services 206. The context data can include information based on the location of the autonomous vehicle 210, such as nearby points of interest, and information based on passenger preferences. The context engine 226 uses contextual analysis to create context enriched prompts that are provided to the generative AI system 202. In one example, a visually impaired passenger asks, “What's around me?” The context engine 226 enhances this simple query by adding context data gathered from various sources. It accesses the HD map to identify nearby landmarks, such as a historical monument or a popular park. The context engine 226 also uses sensor data to detect current roadside events, like a local festival or a scenic view. Additionally, context engine 226 considers the passenger's preferences, perhaps noting their interest in architecture or nature. By integrating this context, the context engine 226 transforms the query into a detailed prompt for the generative AI system, enabling it to provide a rich, informative response that describes the surroundings in a way that aligns with the passenger's interests and current location.

In exemplary embodiments, utilizing data from the HD map to generate context data offers significant benefits by providing precise and detailed geographic information. This includes annotations of landmarks, points of interest, and road features, which enhance the accuracy and relevance of the context-enriched prompts. By leveraging this detailed mapping, the system can deliver more informed and engaging interactions, aligning responses with the passenger's location and interests. This precision ensures that the autonomous vehicle can offer a tailored and immersive experience, improving the overall quality of the journey for visually impaired passengers.

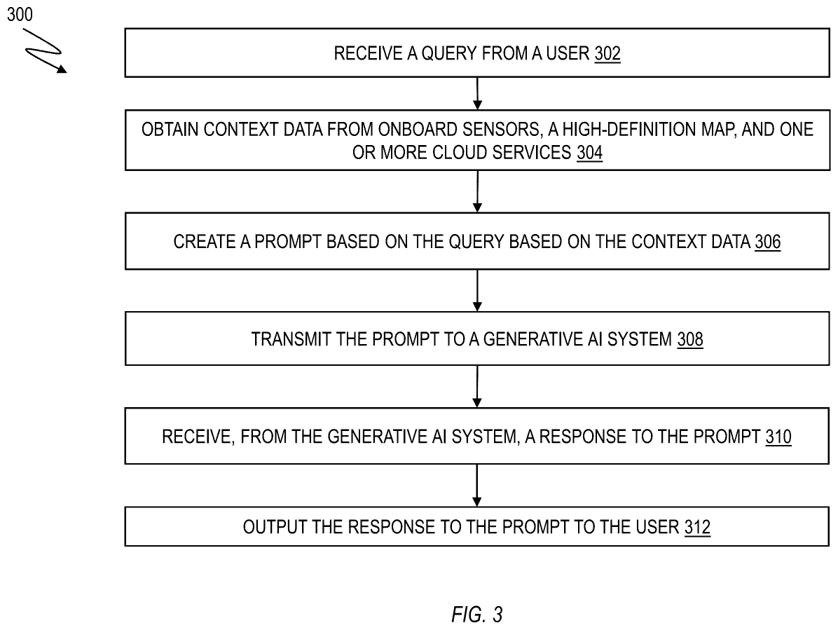

Referring now to FIG. 3, a flowchart diagram of a method 300 for enhancing user interactions with an autonomous vehicle through computer-based context-sensitive responses according to one or more embodiments is shown. In exemplary embodiments, the method 300 is performed by the autonomous vehicle 210 shown in FIG. 2. The method 300 begins at block 302 by receiving a query from a user. In exemplary embodiments, the autonomous vehicle 210 captures the user's input through one or more sensors, which may include questions or requests for information. After the user input is received, the context engine 226, the process of contextual analysis, is initiated. The user query serves as the starting point for generating a context-sensitive response, leveraging the vehicle's onboard systems and external data sources.

At block 304, the method 300 includes obtaining context data from onboard sensors, a high-definition map, and one or more cloud services to gather relevant information to enrich the user's query. In exemplary embodiments, the sensors 214 capture real-time environmental data, while the HD map 212 provides detailed geographic information. In exemplary embodiments, the cloud services 206 supply additional data such as weather updates, news, and events. This integration ensures a comprehensive understanding of the current context, enabling the system to tailor responses to the user's needs.

As shown at block 306, the method 300 includes creating a prompt based on the query and context data. In exemplary embodiments, creating the prompt involves synthesizing the gathered information into a coherent prompt for the generative AI system 202. The prompt includes details about the user's location, nearby points of interest, and any pertinent roadside events, ensuring that the AI system receives a well-rounded input for generating a response.

In one example, a user provides the following query, “What's around me?” The query prompts the context engine 226 to gather context relevant data. The obtained context data indicates that the user is located in Central Park, New York City, near Bethesda Terrace. Nearby points of interest include The Mall, where a local art festival is taking place, and the Central Park Zoo. The user has expressed an interest in art and nature. Using this information, the context engine generates a prompt: “The user is currently at Central Park, near Bethesda Terrace. Nearby points of interest include The Mall, where a local art festival is taking place, and the Central Park Zoo. The user has shown interest in art and nature. Provide information about these attractions and any ongoing events that align with the user's interests.”

In another example, the user query, “Describe the scenery,” prompts the context engine 226 to gather relevant data. The context data indicates that the user is traveling along the Pacific Coast Highway. The onboard sensors capture an image of a nearby lighthouse and a scenic ocean view. Additional context data includes the user's interest in coastal landmarks and photography. Using this information, the context engine generates a prompt: “The user is currently traveling along the Pacific Coast Highway. A captured image shows a lighthouse and a scenic ocean view. The user has shown interest in coastal landmarks and photography. Provide a detailed description of the lighthouse and the surrounding scenery, highlighting features that align with the user's interests.” In some embodiments, sounds associated with the scenery in the surrounding area may also be provided to the user.

Next, as shown at block 308, the method 300 includes transmitting the prompt to a generative AI system 202, which involves sending the context-enriched prompt to the generative AI system 202. This system, which may include any generative AI model known and understood in the art, processes the prompt to generate content that addresses the user's query. In exemplary embodiments, the communication module 220 facilitates this data exchange, ensuring a seamless connection between the autonomous vehicle 210 and the generative AI system 202.

At block 310, the method 300 includes receiving, from the generative AI system 202, a response to the prompt. In exemplary embodiments, the response is crafted based on the enriched prompt, providing information that is both relevant and contextually appropriate. In exemplary embodiments, the processing system 218 integrates this response with other data sources, preparing the integrated response for delivery to the user. In one embodiment, the processing system 218 receives a response from the generative AI 202 system detailing the history of a nearby landmark. Simultaneously, the processing system 218 receives real-time weather data from cloud services 206 and recent news about a local festival from social media feeds. The processing system 218 integrates these diverse data sources, creating a comprehensive response that includes the landmark's history, current weather conditions, and information about the festival. This integrated response is then prepared for delivery, ensuring the user receives a rich, contextually relevant update during their journey.

At block 308, the method 300 includes outputting the response to the prompt to the user 312, which may involve converting the AI-generated content into a format accessible to the user. In exemplary embodiments, the speech processing module 222 is configured to perform this step by transforming text-based responses into spoken language. The speech processing module 222 ensures that the information is delivered in a clear and engaging manner, enhancing the user's experience by providing interactive and informative feedback during the journey.

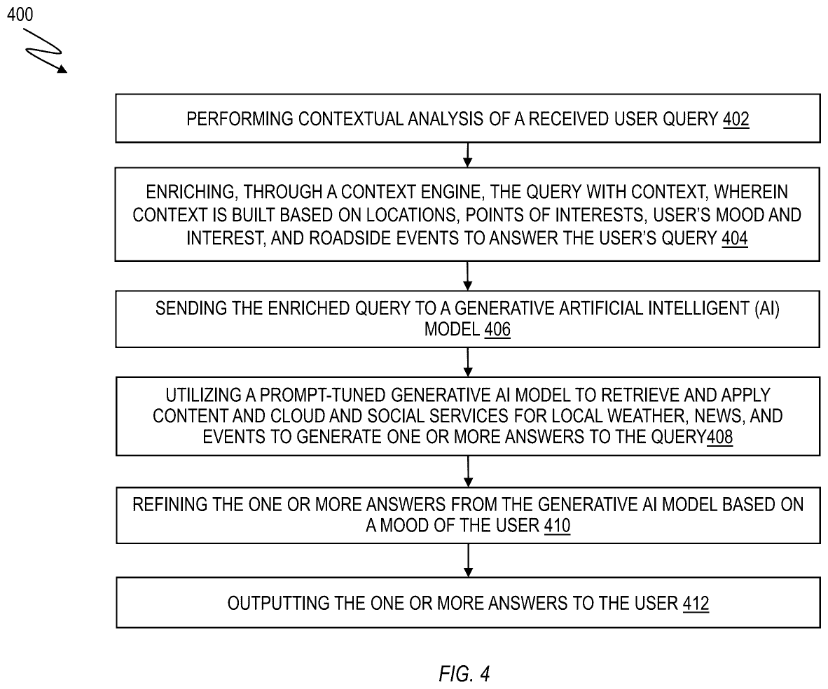

Referring now to FIG. 4, a flowchart diagram of a method 400 for enhancing user interactions with an autonomous vehicle through context-sensitive responses according to one or more embodiments is shown. In exemplary embodiments, the method 400 is performed by the autonomous vehicle 210 shown in FIG. 2. The method 400 begins at block 402 by performing contextual analysis of a received user query. In exemplary embodiments, performing contextual analysis of a received user query includes the initial step of understanding the user's input within the context of the current environment. The context engine 226 is configured to gather contextual data from various sources such as the HD map 212, sensors 214, and cloud services 206. The contextual analysis identifies relevant factors such as the user's location, nearby points of interest, and current roadside events. This analysis is used for enriching the user's query, ensuring that the subsequent interactions are tailored to the user's specific situation and preferences.

Next, as shown at block 404, the method 400 includes enriching the query with context data. In exemplary embodiments, the context engine 226 is configured to enrich the query with context data by integrating data from multiple sources to provide a comprehensive understanding of the user's environment. The context engine 226 utilizes information from the HD map 212 to identify geographic locations and points of interest. Additionally, sensors 214 capture real-time data about the user's mood and interests, as well as any roadside events. This enriched context is important for generating relevant and meaningful responses to the user's query, enhancing the overall interaction with the autonomous vehicle 210.

Next, as shown at block 406, the method 400 includes sending the enriched query to a generative artificial intelligent (AI) model by transmitting the contextually enhanced query to the generative AI system 202. The generative AI system 202, which may include advanced generative AI models that are known and understood in the art, processes the enriched query to generate content that addresses the user's needs. The communication module 220 facilitates this data exchange, ensuring a seamless connection between the autonomous vehicle 210 and the generative AI system 202. As shown at block 408, the method 400 includes utilizing a prompt-tuned generative AI model accesses various external data sources to generate comprehensive answers.

Next, as shown at block 410, the method 400 includes refining the one or more answers from the generative AI model based on a mood of the user. In exemplary embodiment, the refining involves tailoring the AI-generated responses to align with the user's preferences and emotional state. The processing system 218 integrates feedback from the sensors 214, which detect the user's mood and interests, to refine the content. This refinement ensures that the information is not only accurate but also engaging and suitable for the user's current disposition, enhancing the overall interaction with the autonomous vehicle 210.

The method 400 ends at block 412 by outputting the one or more answers to the user. In exemplary embodiments, the speech processing module 222 is configured to convert text-based answers into spoken language. The speech processing module 222 ensures that the information is presented clearly and engagingly, allowing the user to enjoy an interactive and informative journey. The output is tailored to the user's preferences, providing a personalized and enjoyable experience.

In exemplary embodiments, the processing system 218 is configured to initiate a conversation using a prompt-tuned generative AI model to provide generic content. The processing system 218 is designed to engage users by generating relevant and informative dialogue. The processing system 218 is configured to access cloud services to gather real-time data on local weather, news, and events. This integration ensures that the conversation is enriched with current and contextually appropriate information. By leveraging these external data sources, the system delivers a dynamic and engaging interaction, offering users timely updates and insights during their journey.

In exemplary embodiments, a user profile is used to store information about the user's interests and other relevant data to enhance interactions with the autonomous vehicle. This profile includes preferences such as favorite topics, frequently visited locations, and preferred types of information, like art or nature. The processing system 218 accesses the user profile to tailor responses and initiate conversations that align with the user's interests. By integrating this personalized data, the vehicle can provide more relevant and engaging content, ensuring a customized and enjoyable experience for the user. Additionally, the profile can store feedback from previous interactions, allowing the system to continuously refine and improve its responses based on the user's evolving preferences.

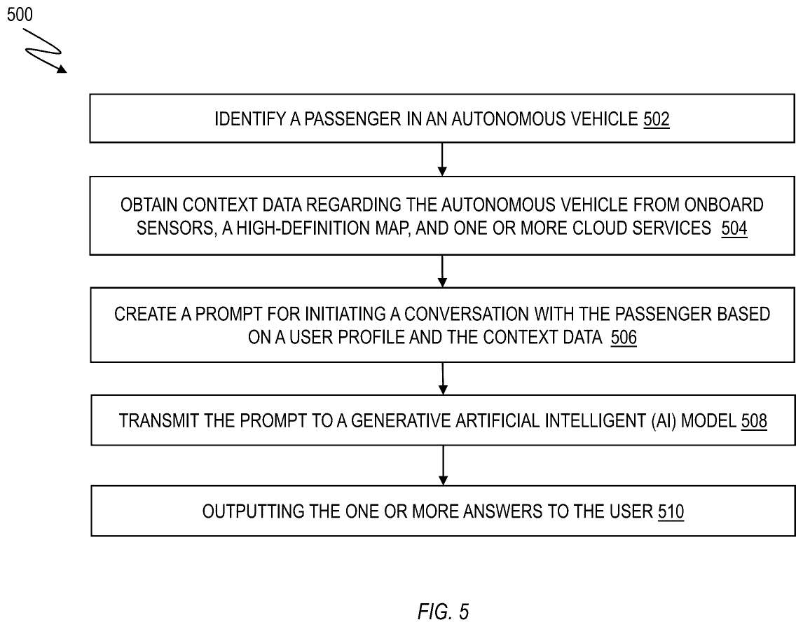

Referring now to FIG. 5, a flowchart diagram of a method 500 for enhancing user interactions with an autonomous vehicle through context-sensitive responses according to one or more embodiments is shown. In exemplary embodiments, the method 500 is performed by the autonomous vehicle 210 shown in FIG. 2. The method 500 begins at block 502 by identifying a passenger in an autonomous vehicle. In exemplary embodiments, the passenger is identified using onboard systems, such as cameras or user profiles, ensuring personalized interaction. For example, the vehicle's system might recognize a passenger by matching their face with stored data.

Next, as shown at block 504, the method 500 includes obtaining context data regarding the autonomous vehicle from onboard sensors, a high-definition map, and cloud services. For example, sensors might detect the vehicle's location on a scenic route, while cloud services provide real-time weather updates, creating a comprehensive context for interaction. As shown at block 506, the method 500 includes using this context data and a user profile of the identified passenger to create a prompt to initiate a conversation with the passenger. For example, based on a determination that the passenger is near a historical site and interested in history, the prompt might be: “Would you like to learn about the nearby landmark?” As shown at block 508, the context-enriched prompt is then transmitted to a generative AI model, such as ChatGPT, International Business Machines (IBM) Granite Models, or watsonx.ai, for processing. The AI model generates a detailed response based on the prompt, ensuring the content is relevant and engaging. As shown at block 510, the AI-generated response is delivered to the passenger through the vehicle's audio system, narrating the history of the landmark and providing an informative and enjoyable experience.

In one embodiment, a user device, such as a smartphone, interfaces with the autonomous vehicle to facilitate the acquisition of vehicle-specific content data. The smartphone employs a communication module to establish a connection with the autonomous vehicle's onboard systems. This connection enables the smartphone to access data from the vehicle's high-definition map and onboard sensors, which provide detailed information about the vehicle's current location and surrounding environment. The smartphone retrieves this data to enhance the user's interaction with the autonomous vehicle, ensuring that the content delivered is contextually relevant and tailored to the user's preferences. Once the smartphone receives the vehicle-specific content data, the smartphone processes this information to create a context-enriched prompt. This prompt incorporates details such as the vehicle's location, nearby points of interest, and any detected roadside events. The smartphone then transmits this prompt to a generative AI system, which generates a response based on the enriched context. The AI system processes the prompt to produce content that aligns with the user's interests and the current environment, ensuring a personalized and engaging interaction. The smartphone receives the AI-generated response and utilizes a speech processing module to convert the text-based content into spoken language. This conversion allows the user to receive the information audibly, enhancing accessibility and engagement. The smartphone delivers the spoken response to the user, providing a seamless and interactive experience that enriches the travel journey. By leveraging the smartphone's capabilities, the system ensures that the user receives timely and relevant updates, enhancing the overall interaction with the autonomous vehicle.

In exemplary embodiments, by receiving a query from the passenger within the autonomous vehicle, the system initiates an interaction that is tailored to the passenger's needs, enhancing the accessibility and engagement for visually impaired passengers. Obtaining context data from onboard sensors, a high-definition map, and cloud services allows the system to gather comprehensive information about the vehicle's location and surroundings. This integration ensures that the responses are relevant and contextually appropriate, providing a more immersive experience for the passenger. Creating a context-enriched prompt based on the query and obtained context data enables the system to generate responses that are not only accurate but also aligned with the passenger's current environment and interests. This approach transforms a routine journey into an interactive and enjoyable experience. Transmitting the context-enriched prompt to a generative AI system leverages advanced AI capabilities to produce detailed and informative responses, enhancing the quality of interaction between the passenger and the vehicle. Converting the response into a spoken response using a speech processing module ensures that the information is accessible to visually impaired passengers, providing clear and engaging audio feedback that enhances the overall travel experience. Outputting the spoken response to the passenger allows for real-time interaction, making the journey more interactive and enjoyable by providing timely and relevant information tailored to the passenger's context and preferences.

In another exemplary embodiments, all the conversation results with passenger query, preferences, context, and responses, together with the passenger feedback can be cached in a cloud or vehicle control center, and replicated locally to promptly reply a passenger query.

While the foregoing is directed to embodiments of the present disclosure, other and further embodiments of the present disclosure may be devised without departing from the basic scope thereof, and the scope thereof is determined by the claims that follow.

What is claimed is:

1. A computer-implemented method for providing context-sensitive interactions between an autonomous vehicle and a passenger, the method comprising:
receiving a query from the passenger within the autonomous vehicle;
obtaining context data from onboard sensors, a high-definition map, and one or more cloud services, wherein the context data includes information about a location of the autonomous vehicle;
creating a context-enriched prompt based on the query and the obtained context data;
transmitting the context-enriched prompt to a generative AI system to generate a response;
receiving the response from the generative AI system;
converting the response into a spoken response using a speech processing module; and
outputting the spoken response to the passenger.

2. The method of claim 1, further comprising identifying the passenger and obtaining a user profile for the passenger.

3. The method of claim 2, wherein creating the context-enriched prompt further comprises including passenger preferences from the user profile of the passenger.

4. The method of claim 1, wherein the high-definition map provides detailed annotations of geographic areas, including landmarks and points of interest, to enhance the context data used for generating the context-enriched prompt.

5. The method of claim 1, wherein obtaining context data from cloud services includes retrieving real-time information such as weather updates, traffic conditions, and local events to enhance the context-enriched prompt.

6. The method of claim 1, wherein creating a context-enriched prompt further comprises synthesizing the obtained context data by incorporating the location of the autonomous vehicle, nearby points of interest, and real-time data obtained from the cloud services.

7. The method of claim 1, wherein converting the response into spoken language using a speech processing module further comprises adjusting one or more of a tone, pace, and style of the spoken response based on a detected mood of the passenger.

8. The method of claim 1, wherein a query is generated from the autonomous vehicle based on passenger's current mode and preferences by using the context, including landmarks and points of interest.

9. A system comprising:
a memory comprising computer readable instructions; and
a processing device for executing the computer readable instructions, the computer readable instructions controlling the processing device to perform operations comprising:
receiving a query from a passenger within an autonomous vehicle;
obtaining context data from onboard sensors, a high-definition map, and one or more cloud services, wherein the context data includes information about a location of the autonomous vehicle;
creating a context-enriched prompt based on the query and the obtained context data;
transmitting the context-enriched prompt to a generative AI system to generate a response;
receiving the response from the generative AI system;
converting the response into a spoken response using a speech processing module; and
outputting the spoken response to the passenger.

10. The system of claim 9, wherein the operations further comprise identifying the passenger and obtaining a user profile for the passenger.

11. The system of claim 10, wherein creating the context-enriched prompt further comprises including passenger preferences from the user profile of the passenger.

12. The system of claim 9, wherein the high-definition map provides detailed annotations of geographic areas, including landmarks and points of interest, to enhance the context data used for generating the context-enriched prompt.

13. The system of claim 9, wherein obtaining context data from cloud services includes retrieving real-time information such as weather updates, traffic conditions, and local events to enhance the context-enriched prompt.

14. The system of claim 9, wherein creating a context-enriched prompt further comprises synthesizing the obtained context data by incorporating the location of the autonomous vehicle, nearby points of interest, and real-time data obtained from the cloud services.

15. The system of claim 9, wherein converting the response into spoken language using a speech processing module further comprises adjusting one or more of a tone, pace, and style of the spoken response based on a detected mood of the passenger.

16. The system of claim 9, wherein a query is generated from the autonomous vehicle based on passenger's current mode and preferences by using the context, including landmarks and points of interest.

17. A computer program product for dynamic auto-scaling a workload deployed in a cloud environment, the computer program product comprising:
a set of one or more computer-readable storage media;
program instructions, collectively stored in the set of one or more storage media, for causing a processor set to perform the following computer operations:
receiving a query from a passenger within an autonomous vehicle;
obtaining context data from onboard sensors, a high-definition map, and one or more cloud services, wherein the context data includes information about a location of the autonomous vehicle;
creating a context-enriched prompt based on the query and the obtained context data;
transmitting the context-enriched prompt to a generative AI system to generate a response;
receiving the response from the generative AI system;
converting the response into a spoken response using a speech processing module; and
outputting the spoken response to the passenger.

18. The computer program product of claim 17, wherein the operations further comprise identifying the passenger and obtaining a user profile for the passenger.

19. The computer program product of claim 18, wherein creating the context-enriched prompt further comprises including passenger preferences from the user profile of the passenger.

20. The computer program product of claim 17, wherein the high-definition map provides detailed annotations of geographic areas, including landmarks and points of interest, to enhance the context data used for generating the context-enriched prompt.
